(19) United States
(12) Patent Application Publication
(10) Pub. No.: US 2012/0192461 A1
(43) Pub. Date: Aug. 2, 2012

(54) SYSTEM FOR ATTACHING ITEMS TO FOOTWEAR

(75) Inventor: Peter P. Backus, Newberg, OR (US)

(73) Assignee: Chinook Trading Company, Lake Oswego, OR (US)

(21) Appl. No.: 13/019,178

(22) Filed: Feb. 1, 2011

(51) Int. Cl. A43B 23/24; F16B 2/20; A43C 19/00

(52) U.S. Cl. 36/136; 24/3.1; 24/3.12

(57) ABSTRACT

A system for attaching a tool to a boot or other footwear includes a first coupling element which is attached to the outside of the boot, and a second coupling element which is attached to an implement and is releasably attachable to the first coupling element. The coupling elements may include a securing element which holds the second coupling element on the first coupling element.

### BACKGROUND OF THE INVENTION

This invention relates to coupling mechanisms for releasably attaching tools and other implements to boots.

It is common to attach a tool or another implement to a boot so that it is readily available when needed. In the past, this has been accomplished in two ways. One way is to attach a pocket on the boot and then insert the tool into the pocket. However, the pocket must be sized large enough to carry a variety of tools, and when a tool that is smaller than the pocket is inserted into the pocket, it can easily fall out when the person wearing the boot moves. The other way is to provide a generic clip on the tool and the user attaches this clip to the top of the boot. While this attaches the tool better than placing it in a pocket, a generic clip will not work in every situation and, if the clip is in contact with the leg of the person wearing the boot, it can cause irritation. Moreover, the clip can become dislodged when the wearer moves.

### BRIEF SUMMARY OF THE INVENTION

A system for releasably attaching an implement to a boot or other footwear includes a first coupling element which is attached to the side of the boot. A second coupling element is attached to the tool or other implement. The first and second coupling elements can be joined to attach the tool or implement to the side of the boot.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a side elevation view of a boot embodying the coupling system of the subject invention.

FIG. 2 is a perspective view, at an enlarged scale of the coupling system shown in FIG. 1.

FIGS. 3 and 4 are perspective views of alternate versions of an element of the coupling system.

FIG. 5 is a cross-sectional view taken on line 5-5 in FIG. 3.

FIG. 6 is a cross-sectional view taken on line 6-6 in FIG. 4.

FIG. 7 is a cross-sectional view taken on line 7-7 of FIG. 2 with an implement attached.

FIG. 8 is a perspective view of another embodiment of the invention.

FIG. 9 is a prospective view of a boot embodying an alternative embodiment of the coupling system.

FIG. 10 is a cross sectional view, at an enlarged scale, taken along the lines 10-10 on FIG. 9.

FIG. 11 is an exploded view of the coupling elements of the embodiment shown in FIG. 9.

FIG. 12 is an exploded perspective view, looking from the rear of the embodiment shown in FIG. 9.

FIG. 13 is an exploded perspective view, looking from the front of the embodiment shown in FIG. 9.

FIG. 14 is a perspective view looking from the rear of the coupling elements of another embodiment of the invention.

### DETAILED DESCRIPTION OF PREFERRED EMBODIMENT

Referring to the drawings, a first coupling element 10 is arranged to be attached to a piece of footwear, such as a boot 12. In the embodiment shown in the drawings, the first coupling element is attached to the outer face 13 of the boot upper. The first coupling element can be attached to the boot by any conventional means, such as through a plate 11 which is embedded between layers of the boot or by rivets. A second coupling element 14 is attached to an implement 16. The second coupling element can be attached to the implement by any conventional means, such as an adhesive. The second coupling element is configured to releasably attach to the first coupling element. Thus, when the first coupling element 10 is attached to the boot 12, the second coupling element and the attached implement 16, can quickly and easily be attached to and removed from the boot whenever it is necessary. The coupling elements 10, 14 may include a securing element which holds the first coupling means on the second coupling means so that it does not become inadvertently dislodged.

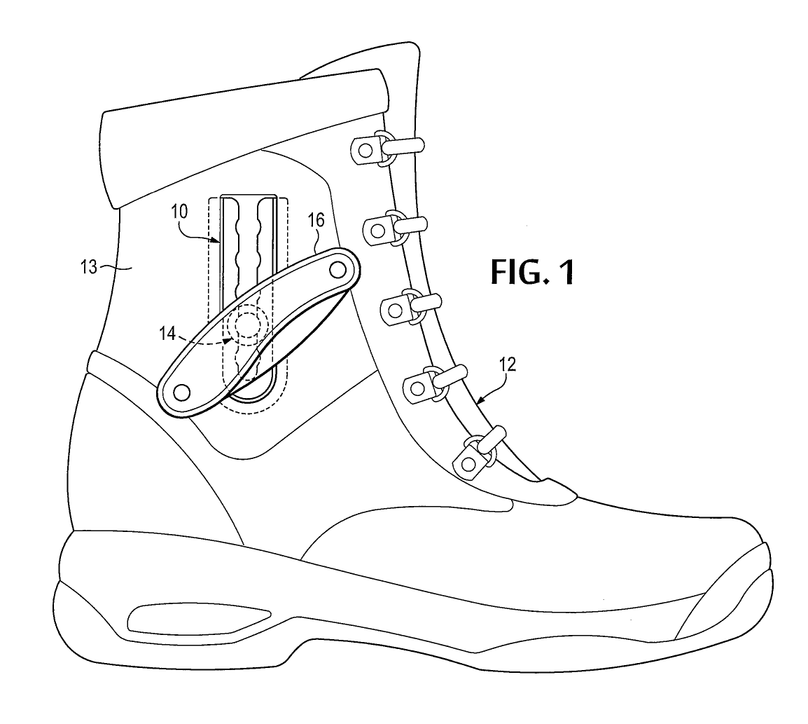

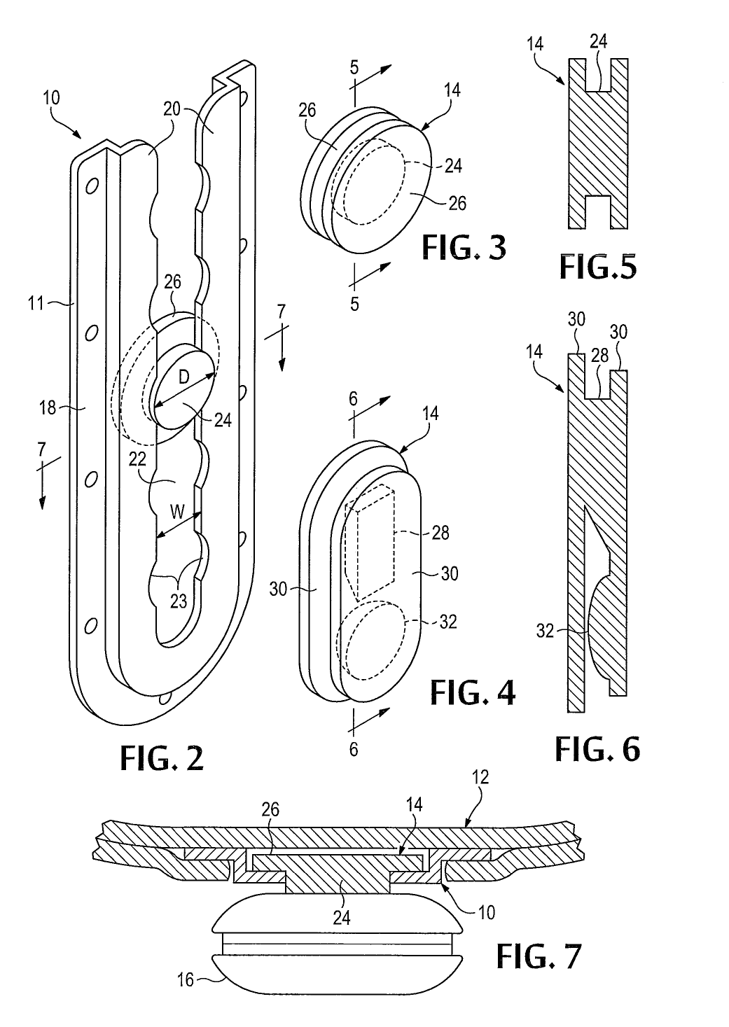

In a first embodiment, shown in FIGS. 1-7, the first coupling element is a U-shaped bracket 18. The bracket has opposed rails 20 which are separated from one another to form a slot 22 having a defined width W. The rails 20 may have a series of opposed recesses 23 formed in them so that the portions of the slot at a pair of recesses is wider than the width W. This first coupling element can either be made from metal or from a hard plastic material such as thermoplastic polyurethane “TPU”.

Referring now also to FIGS. 3 and 5 a first embodiment of the coupling element 4 has a cylindrical slider 24 which has a diameter D which is slightly greater than the width W of the slot, but less than the largest distance between opposed recesses 23. Located on each side of the slider 24 is a cylindrical flange 26 which has a larger diameter than the slider. The slider 24 has a length which is equal to the thickness of the rails so that one of the flanges 26 fits on either side of the rails 20 when the slider is inserted into the slot 22. The slider preferably is made from a hard plastic material such as TPU. Because the diameter D of the slider 24 is greater than the width of the slot W, the slider must be deformed slightly as the second coupling element is pushed onto the first coupling element. However, the slider 24 then expands to its original diameter when it is located between a pair of recesses 23, which acts as a detent to hold the second coupling on the first coupling and prevent the implement 16 from inadvertently being removed from the boot.

In a second embodiment of the second coupling element 10, shown in FIGS. 4 and 6, the slider 28 is rectangular and has a width which is the same or slightly less than the width W of the slot 22. In this embodiment, the flanges 30 have rectangular center sections and semicircular ends. Located below the slider is a spherical protrusion 32 which at its base has a width which is greater than the width W but less than the largest distance between opposed recesses 23. The protrusion is made from a hard plastic material, such as TPU. Thus, the protrusion acts as a detent similar to the slider in the first embodiment of the first coupling element.

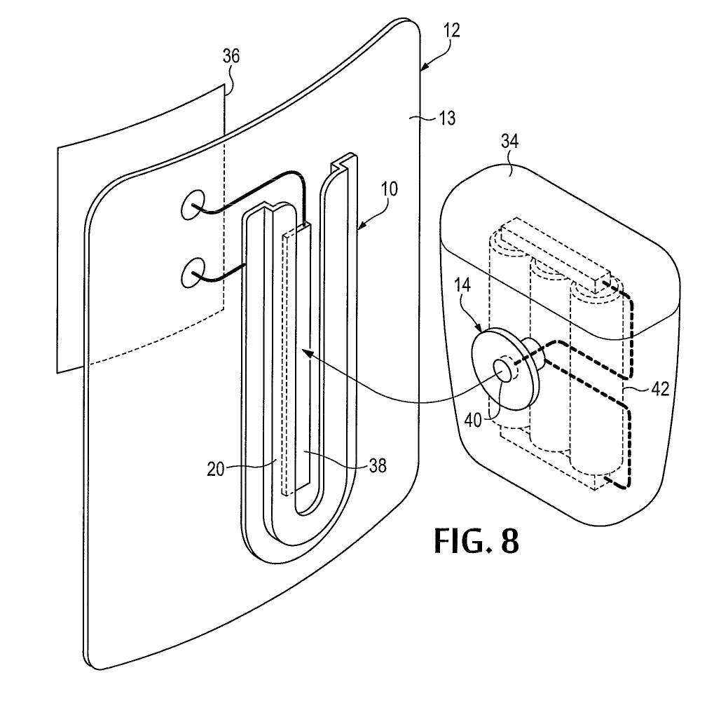

In another embodiment of the tool shown in FIG. 8, the implement is a battery pack 34. In this embodiment the boot has an electrically powered device 36 located in it. The device could be a heater, a cooling fan, a mechanism for extending retractable spikes or other similar devices. A first electrical connector 38 is located on the first coupling element 10 and a second electrical connector 40 is located on the second coupling element 14. The two electrical connectors make electrical contact when the second coupling element 14 is placed on the first coupling element 10. The second electrical connector 40 is connected to batteries 42 located in the battery pack 34. The batteries then power the electrically powered device 36.

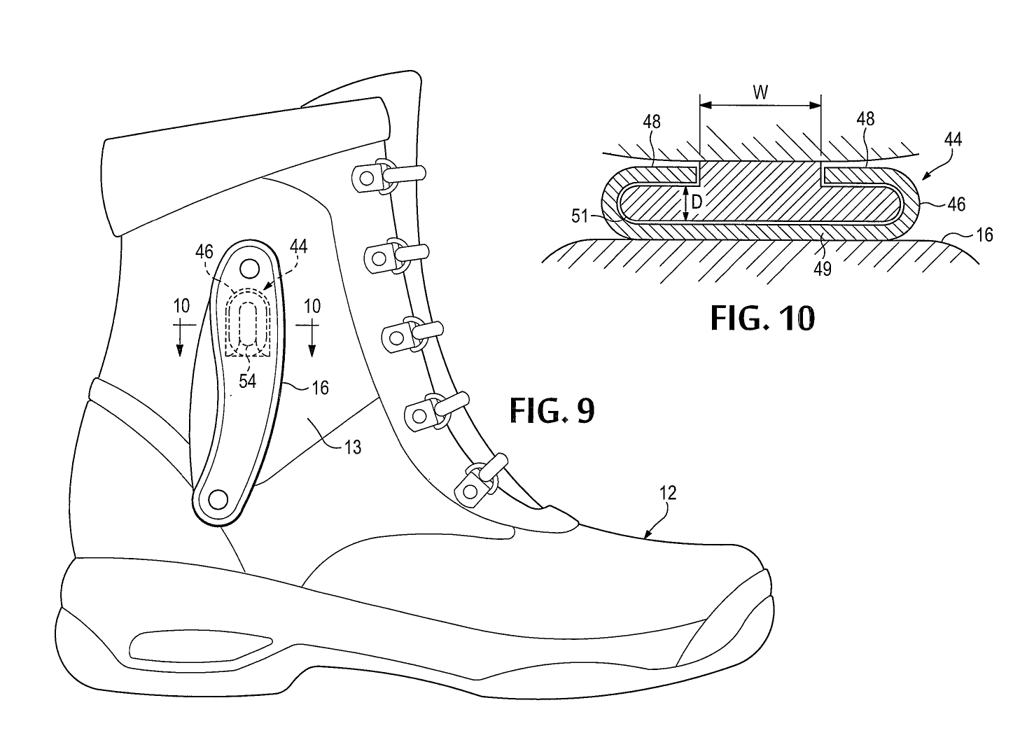

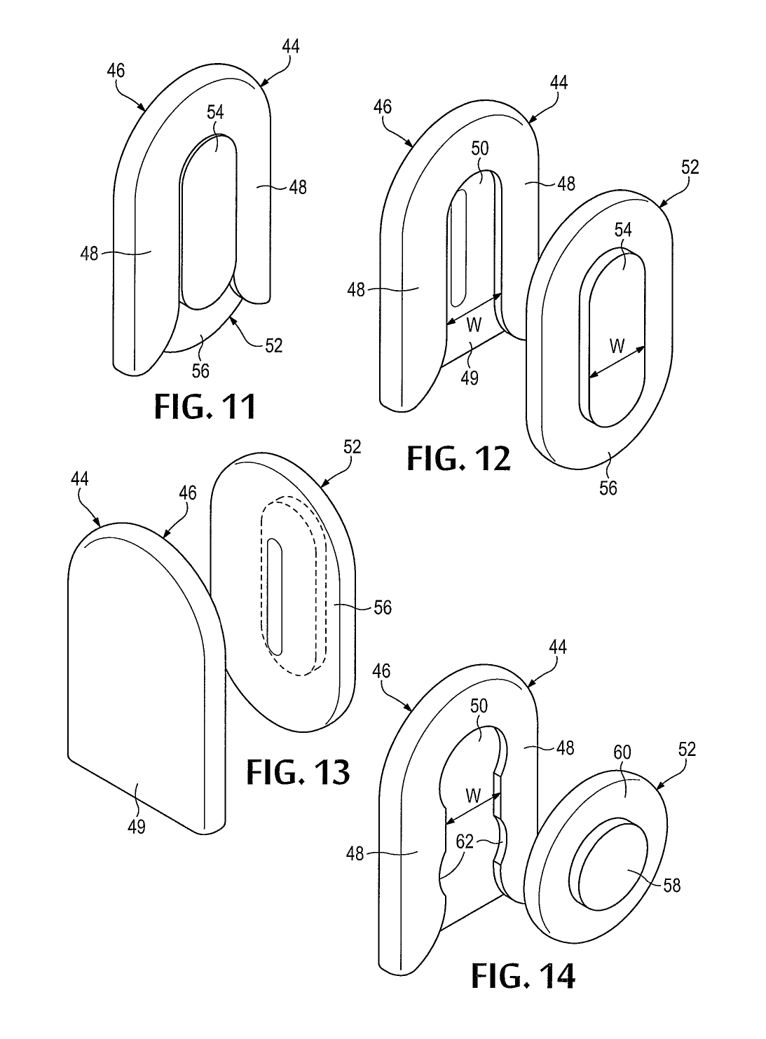

In another embodiment of the invention shown in FIGS. 9-13, the second coupling element 44 is a U shaped clip 46 having opposed rails 48 on its inner side and a solid wall 49 on its outer side. The rails are separated from one another side to side to form a slot 50 having a width W. The rails 48 are separated from the wall 49 by a distance D to form a pocket 51. The solid wall 49 of the clip 46 is attached to the implement 16 by conventional means, such as an adhesive. The clip 46 can be made from metal or from a hard plastic material, such as TPU.

In this embodiment the first coupling element 52 is similar to the embodiment of the second coupling element shown in FIG. 4. The coupling element 52 includes a slider 54 which has a width w which is equal to or slightly smaller than the width W of the slot 50. One side of the slider 54 is attached to the boot 12, and the other side is attached to a flange 56. The flange 56 is larger than the slider 54 and is configured to fit snuggly in the pocket 51 in the clip 46.

Referring now to FIG. 14, if desired the slot 50 in the clip 46 can have opposed recesses 62 and the first coupling element 52 can have a cylindrical slider 58 and a cylindrical flange 60. The slider 58, recesses 62 and slot 50 are sized similar to the slot 22, recesses 23 and slider 24 in the first embodiment of the invention and hold the first coupling element 52 on the second coupling element 44.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A system for releasably attaching an implement to footwear comprising:
(a) a first coupling element which is attached to an outside face of said footwear;
(b) a second coupling element which is attached to an implement;
(c) said first coupling element being releasably attachable to said second coupling element.

2. The system of claim 1 including a securing element which holds said second coupling element on said first coupling element.

3. The system of claim 1 wherein said first coupling element is a bracket having opposed inwardly facing rails defining a slot having a first width.

4. The system of claim 3 including a securing element which holds said second coupling element on said first coupling element, wherein said rails have opposed recesses which open into said slot.

5. The system of claim 4 wherein said first coupling element comprises a slider which slidably fits in said slot, wherein said slider has a width which is greater than said first width.

6. The system of claim 5 wherein said rails have a thickness and said slider has opposed ends and a length which is slightly larger than said thickness, and said second coupling element comprises flanges, one of said flanges being located on each end of said slider.

7. The system of claim 4 wherein said second coupling element comprises a slider which slidably fits in said slot and a spherical protrusion which fits in said slot, said protrusion has a width which is greater than said first width.

8. The system of claim 7 wherein said rails have a thickness and said slider has opposed ends and a length which is slightly larger than said thickness and said second coupling element comprises flanges, one of said flanges being located on each end of said slider.

9. The system of claim 1 wherein said implement is a tool.

10. The system of claim 1 wherein said footwear has an electrically powered device located therein, said system further comprising:
(a) a first electrical contact located on said first coupling element;
(b) a second electrical contact located on said second coupling element;
(c) said first electrical contact being connected to said electrically powered device;
(d) said first and second electrical contacts being interconnected when said second coupling element is attached on said first coupling element; and
(e) a battery pack attached to said second coupling element, said battery pack configured to connect batteries located therein within with said second electrical connector.

11. A system for releasably attaching an implement to footwear, comprising:
(a) a boot having an outer surface;
(b) a first coupling element attached to said outer surface;
(c) an implement;
(d) a second coupling element attached to said implement; and
(e) said first coupling element being releasably attachable to said second coupling element.

12. The system of claim 1 wherein:
(a) said second coupling element is a U shaped clip having opposed inwardly facing rails on an inner side thereof, said rails defining a slot having a first width;
(b) said clip having a wall on an outer side thereof; wherein
(c) said rails are separate from said wall to form a pocket therebetween.

13. The system of claim 12 wherein said first coupling element comprises:
(a) a slider which slidably fits in said slot and has a second width which is greater than said first width; and
(b) a flange which is attached to said slider and fits into said pocket

14. The system of claim 13 wherein said rails have a thickness and said slider has a length which is slightly larger than said thickness, and said first coupling element includes a flange, which is attached to said slider and fits in said pocket.

15. The system of claim 12 wherein said footwear has an electrically powered device therein, said system further comprising:
(a) a first electrical contact located on said first coupling element;
(b) a second electrical contact located on said second coupling element;
(c) said first electrical contact being connected to said electrical power device;
(d) said first and second electrical contact being inter connected when said second coupling element is attached to said first coupling element; and
(e) a battery pack attached to said second coupling element, said battery pack configured to connect batteries located therein with said second electrical connector.
